(19) United States
(12) Patent Application Publication
(10) Pub. No.: US 2004/0188540 A1
(43) Pub. Date: Sep. 30, 2004

(54) Adjustable height inverted lawn and garden sprinkler

(76) Inventor: Derba Mills, San Antonio, TX (US)

Correspondence Address: Derba Mills, 8518 Timber West, San Antonio, TX, 78250, US

(21) Appl. No.: 10/401,313

(22) Filed: Mar. 27, 2003

(51) Int. Cl. B05B 15/10

(52) U.S. Cl. 239/280

(57) ABSTRACT

An adjustable height inverted lawn and garden sprinkler is disclosed. The embodiment of the invention includes an integral base assembly, telescoping water pipe, swivel, water control valves, and sprinkler wands, said base attached to lower end of telescoping water pipe, said swivel attached to opposite end of telescoping water pipe, water control valves attached to a tee at the other end of said swivel and at right angles of said telescoping water pipe, and said wands attached to water control valves by threaded connection or other standard attachment means.

### BACKGROUND OF THE INVENTION

The use of lawn and garden sprinklers is well known in the prior art. More specifically, conventional sprinklers heretofore devised and utilized are known to consist of basically familiar, expected, and obvious structural configurations, notwithstanding the myriad of designs encompassed by the crowded prior art which have been developed for the fulfillment of countless objectives and requirements. While these devices fulfill their respective, particular objectives and requirements, the aforementioned devices for hydrating lawns and gardens using most conventional methods waste water. Specifically current systems on the market project water from a base on the ground. The water arcs up, then splashes down to the lawn, wasting water through evaporation. Other sprinklers may force the water across the area to be hydrated, also losing moisture.

U.S. Pat. Nos. 5,224,652 and 4,934,001 use raised water sprinkling, but the devices are used for water entertainment. While the devices may fulfill their respective, particular objective and requirements, the aforementioned patents are not designed for irrigation of lawns and gardens.

Accordingly, a need still remains for an improved method to efficiently irrigate lawns and gardens.

### BRIEF SUMMARY OF THE INVENTION

The primary object of the invention is to provide a sprinkler that efficiently irrigates lawns and gardens using a raised sprinkler assembly that sprays water in a downward direction through inverted spray wands.

Another object of the invention is to provide a sprinkler that saves water by reducing evaporation.

Another object of the invention is to provide a sprinkler that is easy to use.

A further object of the invention is to provide a sprinkler that adjusts to different heights.

Yet another object of the invention is to provide a sprinkler that is inexpensive to manufacture.

Still another object of the invention is to provide a sprinkler that reduces watering time.

Another object of the present invention is a sprinkler design that may be adapted for residential, commercial, or industrial use.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a adjustable height inverted lawn and garden sprinkler comprising: an integral base assembly, telescoping water pipe, swivel, water control valves, and sprinkler wands, said base attached to lower end of telescoping water pipe, said water control valves attached at right angles to the opposite end of said telescoping water pipe, and said wands attached to water control valves by threaded connection or other standard attachment means.

### BRIEF DESCRIPTION OF SEVERAL VIEWS OF THE DRAWING

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a side view of the adjustable height inverted lawn and garden sprinkler according to the present invention.

FIG. 2 is a plan view of the bottom of the sprinkler wand.

### DETAILED DESCRIPTION OF THE INVENTION

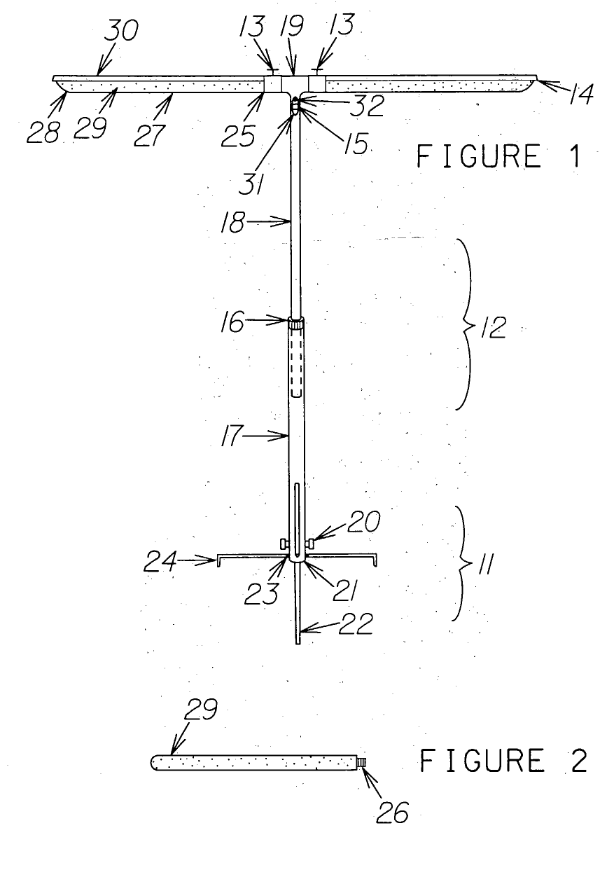

The object of the present invention is to reduce the amount of water and time necessary to irrigate lawns and gardens. To achieve this objective, the embodiment of the present invention includes an adjustable height inverted lawn and garden sprinkler 10 that sprays water in a downward direction. Referring to FIG. 1, the adjustable height inverted lawn and garden sprinkler 10 is comprised of an integral base assembly 11, telescoping water pipe 12, swivel 15, water control valves 13, and sprinkler wands 14. A stake 22 and four lawn claws 24 form the integral base assembly 11. The stake 22 is threaded 21 into the bottom of the outer pipe 17 of the telescoping water pipe 12 for easy removal. The four lawn claws 24 are attached to the outer pipe 17 with locking hinges 23, allowing the claws 24 to fold up against the side of the outer pipe 17 when not in use. The sprinkler 10 can be easily staked in position for garden watering. The combination of the stake 22 and lawn claws 24 keeps the sprinkler 10 stationary during lawn watering.

The telescoping water pipe 12 is attached to the integral base assembly 11 and includes an inner pipe 18 extending from an outer pipe 17. An adjustable compression coupling 16 is mounted at the top of the outer pipe 17 and tightens around the inner pipe 18 to allow the sprinkler 10 to adjust to different heights. Hose connectors 20 are located near the bottom of the outer pipe 17 for connection to a garden hose (not shown) so that multiple sprinklers 10 can be connected in series. A swivel connector 15 is attached to the top of the inner pipe 18 to allow the wands 14 to spin. A locking clip 31 is attached to the outside near the top of the inner pipe 18. A tee 19 is attached to the top of the swivel 15. A pin 32 protrudes from the base of the tee connection 19. The locking clip 31 connects to the pin 32 to allow the wands 14 to remain stationary if desired. Water control valves 13, such as ball valves, are attached to each side of the tee 19, with threaded connections 25, or other methods of attachment, facing outward. The water control valves 13 are attached at right angles to the telescoping water pipe 12.

The sprinkler wands 14 are threaded on one end 26 and attach to threaded connections 25 on the water control valves 13. The wands 14 are curved across the bottom 27 and outer ends 28. The entire lengths of the sides and bottom surfaces of the wand 14 are perforated with small holes 29 in a staggered design to produce the optimum sprinkler pattern and to cause to sprinkler to spin on the swivel connection 15. The top 30 of the wand 14 is solid.

Alternately, another embodiment of the present invention includes a multiple outlet connector (not shown) instead of a tee 19 to allow multiple sprinkler wands 14 to be used simultaneously.

While only one embodiment of the present invention has been shown and described, it will be understood that various modifications and changes could be made thereunto without departing from the spirit and scope of the invention.

With respect to the description above, it is to be realized that the optimum dimensional relationship for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered to be illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of this invention.

I claim:

1. An adjustable height inverted lawn and garden sprinkler comprising:
an integral base assembly;
telescoping water pipe;
swivel;
water control valves; and
sprinkler wands,

2. An adjustable height inverted lawn and garden sprinkler according to claim 1; wherein said sprinkler includes spray wands that spray water from the bottom of the wands.

3. An integral base assembly according to claim 1, wherein said base includes a stake and lawn claws.

4. A telescoping water pipe according to claim 1, wherein said pipe includes an inner pipe, outer pipe, and adjustable compression coupling.

5. An adjustable height inverted lawn and garden sprinkler according to claim 1; wherein said sprinkler includes swivel to allow the wands to spin.

6. An adjustable height inverted lawn and garden sprinkler according to claim 1; wherein said sprinkler includes an inlet hose connection and outlet hose connection to allow the sprinklers to be connected in series.

7. An adjustable height inverted lawn and garden sprinkler according to claim 1, wherein said sprinkler includes spray wands wherein the entire lengths of the sides and bottom surfaces of the wands are perforated with small holes in a staggered design to produce the optimum sprinkler pattern and to cause to sprinkler to spin on the swivel connection.
